(19) United States
(12) Patent Application Publication
(10) Pub. No.: US 2022/0181054 A1
(43) Pub. Date: Jun. 9, 2022

(54) MAGNETIC LEVITATION APPARATUS AND MEASUREMENT APPARATUS USING THE SAME

(71) Applicants: Yasuhiro IKEZOE, Minamisaitama-Gun (JP); Masayuki SUGAYA, Minamisaitama-Gun (JP)

(72) Inventors: Yasuhiro IKEZOE, Minamisaitama-Gun (JP); Masayuki SUGAYA, Minamisaitama-Gun (JP)

(73) Assignee: Yasuhiro IKEZOE, Minamisaitama-Gun (JP)

(21) Appl. No.: 17/680,620

(22) Filed: Feb. 25, 2022

Related U.S. Application Data
(63) Continuation of application No. PCT/JP2020/032159, filed on Aug. 26, 2020.

(30) Foreign Application Priority Data
Aug. 30, 2019 (JP) 2019-158501

(51) Int. Cl. H01F 7/02; H02N 15/00

(52) U.S. Cl. CPC H01F 7/0236; H02N 15/00

(57) ABSTRACT

A magnetic levitation apparatus includes a pair of permanent magnets. Each of the pair of permanent magnets includes a side surface, a top surface, and a ridgeline that chamfers a corner connecting the side surface to the top surface in a vertical section. The pair of permanent magnets are magnetized in mutually opposite directions in the vertical direction and are aligned with the side surfaces facing each other or coming into contact with each other, such that a target that is diamagnetic to a medium in an atmosphere is magnetically levitated in a space located above the ridgeline of each of the pair of permanent magnets in the vertical section.

### CROSS REFERENCE TO RELATED APPLICATION

This application is a continuation of International Patent Application No. PCT/JP2020/032159, having an international filing date of Aug. 26, 2020, which designated the United States, the entirety of which is incorporated herein by reference. Japanese Patent Application No. 2019-158501 filed on Aug. 30, 2019 is also incorporated herein by reference in its entirety.

### BACKGROUND OF THE INVENTION

The present disclosure relates to a magnetic levitation apparatus and a measurement apparatus using the same, such as an acceleration sensor or a surface tension sensor.

In the first half of 19th century, Earnshaw proved that only a repulsive force can be used to statically levitate objects using electric fields or magnetic fields. However, it is difficult to generate the repulsive force using electric fields. This is because although it is well known that electrical charges with the same symbol act repulsively on each other, it is substantially not possible to keep electrical charges with a specific symbol (positive or negative) inside an object, the electrical charges that the object has eventually become zero, deviation to either positive or negative electrical charges occurs in the object placed in an electric field depending on a dielectric constant thereof, and an attractive force acts as a result.

As magnetic forces working on an object (magnetic force), two types, namely a force toward a magnet (attractive force) and a force away from a magnet (repulsive force) are present. A magnet exerts an attractive force on ferromagnets such as iron and nickel or paramagnets such as salts of transition metal and oxygen gas. On the other hand, the magnet exerts a repulsive force on water, plastic, a pottery, a wooden material, glass, and many other organic substances. There are called diamagnets. In other words, only systems for generating a repulsive force in the natural world are systems constituted by combinations of magnets (coils or permanent magnets) and diamagnets. On theoretical ground, magnetic levitation of an object can be realized on the Earth by using a repulsive force between a diamagnet and a magnet.

However, the repulsive force between the diamagnet and the magnet is significantly weak, and a super strong magnet is needed to realize magnetic levitation of the diamagnet. In 1991, E. Beaugnon et al., succeeded in magnetic levitation of a diamagnet for the first time in the world by generating a magnetic field that was as strong as B (magnetic flux density)=27 T (tesla) in a strong magnetic field facility in France (Beaugnon, E. & Tournier, R. Nature 349 (1991) 470). Additionally, magnets used for blackboards in schools generate a magnetic flux density of only about 0.1 T even if the magnets are strong magnets. Since magnetic energy is proportional to the square of the intensity of magnetic flux density, the energy of the magnet of 27 T is about 73000 ((27/0.1)) times the energy of the magnet of 0.1 T. Although even the fact that a substance called a “diamagnet” is present is not known in general, it is also possible to state that this is because “there is no such an opportunity to see a state in which a substance acts repulsively from a magnet”. The reason is that the energy that a magnetic field generated by an ordinary magnet has and the energy that a magnetic field generated by a magnet that can realize even magnetic levitation has are different from each other by several tens of thousands of times, and a situation in which a diamagnet receiving a repulsive force from a magnet can be visually observed is not present in nature. Note that the magnet was a superconducting magnet of the world strongest class at the time in 1991, and even at present in 2019, it is necessary to use some of very limited strong magnetic field facilities to obtain a magnetic field of 27 T. Although water is one of substances that can be easily levitated since water has relatively strong diamagnetism among diamagnets, magnetic levitation is realized only under the conditions as described above.

Although magnetic levitation experiments were conducted in some strong magnetic field facilities even after the report of Beaugnon et al., all the experiments were not experiments using magnets used by researches in general companies and universities on a daily basis. Also, since the substances that were able to be levitated are also limited to diamagnets, researches in terms of applications did not advance that much. However, the Magneto-Archimedes principle proposed by the present inventors (JP-A-2002-126495 and Ikezoe Y., et al., Nature, 393 (1998) 749 to 750) in 1998 discloses that magnetic levitation is facilitated by skillfully using a surrounding medium. For example, it has become possible to realize magnetic levitation of water with an ordinary superconducting magnet, and it has become possible to directly observe a state in which water is floating in person for the first time in the world. Also, it has become possible to easily achieve magnetic levitation with a magnetic field that is as weak as that of a permanent magnet by using a paramagnetic solution as a medium, and various researches for magnetic separation, applications to biomaterials, and the like have been carried out all over the world. Also, although the Earnshaw's theorem concluded that it was not possible to achieve magnetic levitation of substances that are attracted by magnets, the present inventors also proved that it is possible to achieve magnetic levitation of substances as long as the media are more strongly attracted by magnets than the target substances to be levitated because the target substances are relatively diamagnetic in the systems. In other words, it is the Magneto-Archimedes principle that enables magnetic levitation of all substances. In many of the following researches related to magnetic levitation and magnetic forces, the Magneto-Archimedes principle is used in some forms.

In 2004, Lyuksyutov et al., reported an experiment in which water with a diameter of about 20 to 30 μm was levitated using two fine permanent magnets disposed to face each other with magnetic poles facing each other and an electrode (Lyuksyutov, I. F., et al., Appl. Phys. Lett. 85(10) (2004) 1817 to 1819). However, details regarding how much magnetic force was generated are not written, and whether the water actually floated is not sure. As is obvious from the structure, no restoring force is present in a direction along a clearance between the magnets if no electrode is included. In order to form an electrode, at least a fine working technology such as lithography is needed. Also, since it is necessary to secure the two permanent magnets in a state in which the magnetic poles face each other and strongly repulsively act on each other, the securing should be achieved by adsorbing the magnets to a ferromagnet substrate.

In 2008, Pigot et al., reported an experiment in which a fine Nd—Fe—B magnet pattern of about 50 μm was created and a small piece of bismuth was then magnetically levitated using a lithography technology (Pigot C., et al., IEEE TRANS. MAG., 44(11), (2008) 4521 To 4524). Both the orientations of the magnetic poles of the two magnets are the upward orientation in the vertical direction and are parallel to each other. Although the positional relationship of the magnetic poles is different from that in Lyuksyutov, I. F., et al., Appl. Phys. Lett. 85(10) (2004) 1817 to 1819 described above, the disposition in which the magnets repulsively act on each other is the same. The magnets are attached as thin films to the substrate. In this research, analysis of magnetic field distribution was also conducted. However, it is necessary to create a fine structure similarly to that in Lyuksyutov, I. F., et al., Appl. Phys. Lett. 85(10) (2004) 1817 to 1819, and it is thus not possible to realize the similar experiment with ordinary magnets. Although mention regarding an inclinometer and an acceleration meter is included in the research paper, these were not created in practice.

In 2015, Gunawan et al., reported that it was possible to levitate a carbon rod in a clearance of two columnar magnets disposed to be in contact with each other (Gunawan O., et al., Appl. Phys. Lett. 106 (2015) 062407). There is an indication that the system can be used for measuring magnetic susceptibility of a substance. Although this was a much simpler structure as those of Lyuksyutov, I. F., et al., Appl. Phys. Lett. 85(10) (2004) 1817 to 1819 and Pigot C., et al., IEEE TRANS. MAG., 44(11) (2008) 4521 to 4524, only magnetic levitation of carbon, which was easily levitated, was demonstrated, and magnetic levitation of any other substances was not demonstrated. Also, disposition of the magnetic poles of the magnets that were parallel to the horizontal direction and exerted an attracted force was employed.

In 2015, Iida et al., realized magnetic levitation of carbon in a hollow portion between magnets and a yoke using a method of disposing a total of nine magnets called Halbach disposition in order to enhance a magnetic force for the magnetic levitation (Iida K., et al., Bull. JSME., 2(3) (2015) 14-00559). It was necessary to firmly secure the total of nine repulsing magnets with a lump of metal and a yoke.

In 2002, Watarai et al., released a research paper regarding magnetic chromatography. In the research paper, a method of controlling a moving speed of particles with a magnetic force was discussed, and the fact that a magnetic force generated in magnet disposition used in an experiment was a sufficient magnetic force to realize magnetic levitation of water was discovered (Watarai H. and Namba M., J. Chromatogr., 961(1) (2002) 3 to 8). However, the report indirectly evaluated that “the magnetic force had a magnitude large enough to realize magnetic levitation of water” from experiment data and showed neither results of simulation and actual measurement nor an experiment in which water was actually caused to float. The disposition of the magnets employed here is disposition in which attractive forces are exerted to each other because of the form in which the N pole and the S pole face each other, and the magnetic forces are further enhanced by small iron pieces sandwiched between the magnetic poles. Also, there is a clearance between the small iron pieces, the interval therebetween is 400 μm, and it is possible to presume that the small clearances between the magnets are important to enhance the magnetic forces similar to the previous research papers. Note that although a situation in which the magnetic force along the Z axis (the vertically upward direction) is balanced with gravity acting on water may be achieved by the disposition in the experiment, it is expected that the object will move in the horizontal direction and will then drops if the disposition is kept.

### BRIEF DESCRIPTION OF DRAWINGS

FIG. 1 is a front view of a magnetic levitation apparatus according to a first embodiment of the disclosure.

FIG. 2 is a diagram for explaining the Magneto-Archimedes principle.

FIG. 3 is a diagram illustrating magnetic field intensity distribution in an X-Z plane of the magnetic levitation apparatus illustrated in FIG. 1.

FIG. 4 is a diagram illustrating magnetic field intensity distribution in a Z-axis direction in the magnetic field intensity distribution in the X-Z plane illustrated in FIG. 3.

FIG. 5 is a diagram illustrating a value of B×(∂B/∂Z) calculated from FIG. 4.

FIG. 6 is a front view illustrating a magnetic levitation apparatus according to a second embodiment of the disclosure.

FIG. 7A is a diagram illustrating magnetic field intensity distribution in an X-Z plane of the magnetic levitation apparatus illustrated in FIG. 6, and FIG. 7B is a diagram illustrating magnetic field intensity distribution along the Y axis at a levitation position (Z=0.05 mm) of a liquid droplet when water is levitated.

FIG. 8 is a diagram illustrating a result of magnetic levitation experiment of water.

FIG. 9 is a diagram illustrating a relationship between a fillet radius defining a ridgeline and a magnetic force.

FIGS. 10A to 10C are a perspective view, a front view, and a side view of a magnetic levitation apparatus according to a third embodiment of the disclosure.

FIG. 11A is a diagram illustrating magnetic field intensity distribution in an X-Z plane of the magnetic levitation apparatus illustrated in FIG. 10, and FIG. 11B is a diagram illustrating magnetic field intensity distribution along the Y axis at a levitation position (Z=0.05 mm) of a liquid droplet when water is levitated.

FIG. 12 is a diagram illustrating magnetic field intensity distribution in the Z-axis direction in the magnetic field intensity distribution in the X-Z plane illustrated in FIG. 11A.

FIG. 13 is a diagram illustrating a value of B×(∂B/∂Z) calculated from FIG. 12.

FIG. 14 is a diagram illustrating a measurement apparatus according to a fourth embodiment of the disclosure.

FIG. 15 is a characteristic diagram illustrating a correlation between concentration of a surfactant in a solution and surface tension of the solution.

FIG. 16 is a diagram illustrating oscillation properties of a target to which an external force is applied.

FIG. 17 is a diagram illustrating a measurement apparatus according to a fifth embodiment of the disclosure.

FIG. 18 is a plan view of a support illustrated in FIG. 17.

FIG. 19 is a diagram illustrating a measurement apparatus according to a sixth embodiment of the disclosure.

### DETAILED DESCRIPTION OF THE INVENTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between. Further, when the first element is described as “moving” relative to the second element, such description includes embodiments in which at least one of the first element and the second element moves relative to the other.

An object of the disclosure is to provide a magnetic levitation apparatus capable of magnetically levitate a target with a simple structure.

Another object of the disclosure is to provide a magnetic levitation apparatus capable of magnetically levitating a target with a simple structure and realizing dynamical equilibrium even in a horizontal plane and a measurement apparatus using the same.

(1) An embodiment of the disclosure relates to a magnetic levitation apparatus including: a pair of first permanent magnets (also referred to as a pair of permanent magnets), in which each of the pair of first permanent magnets includes a side surface, a top surface, and a ridgeline that chamfers a corner connecting the side surface to the top surface in a vertical section, the pair of first permanent magnets are magnetized in mutually opposite directions in the vertical direction and are aligned with the side surfaces facing each other or coming into contact with each other, such that a target that is relatively diamagnetic to a medium in an atmosphere is magnetically levitated in a space above the ridgeline of each of the pair of first permanent magnets in the vertical section.

According to an embodiment of the disclosure, the pair of first permanent magnets magnetized in the mutually opposite directions in the vertical direction and aligned with the side surfaces facing each other or coming into contact with each other exert attractive forces antiparallel to each other, such that the target is magnetically levitated in the space located above the ridgeline of each of the pair of first permanent magnets in the vertical section. Here, since the magnet exerts the repulsive force on the target that is relatively diamagnetic to the medium in the atmosphere, it is possible to levitate the target with the magnetic force of the magnet in principle. The magnetic force required for the magnetic levitation includes B×(∂B/∂Z) that is a product of a magnetic flux density B (T) and ∂B/∂Z (T/m) that is a gradient of the magnetic flux density B in the vertical direction. In a case in which relatively small permanent magnets in an embodiment of the disclosure are used, the magnetic flux density B becomes small, but a strong magnetic force is obtained by securing a large gradient (∂B/∂Z) of the magnetic flux density B in the vertical direction.

(2) In the embodiment (1) of the disclosure, the ridgeline of each of the pair of permanent magnets may chamfer the corner connecting the side surface to the top surface in accordance with a predetermined radius. However, a plurality of different curvature radii may be used, or a straight line may be used, for the chamfering.

(3) In the embodiment (2) of the disclosure, B×(∂B/∂Z) that is a product between a magnetic flux density B (T) and ∂B/∂Z (T/m) that is a gradient of the magnetic flux density B in the vertical direction changes depending on the radius, and the radius is set in accordance with a type of the target. For example, it is possible to further enhance the magnetic force by further reducing the radius for a target with larger density or weaker diamagnetism.

(4) In the embodiments (1) to (3) of the disclosure, when the vertical direction is defined as a Z direction, and directions that perpendicularly intersect the Z direction in a horizontal plane are defined as an X direction and a Y direction, the pair of first permanent magnets include the ridgelines in an X-Z section, and each of the pair of first permanent magnets can include the top surface formed into an arc shape projecting downward in a Y-Z section. In this manner, it is possible to realize dynamical equilibrium in which the target is balanced and stabilized even in a horizontal plane by a magnetic field formed by the arc-shaped portion formed at each top surface.

(5) In the embodiments (1) to (3) of the disclosure, when the vertical direction is defined as a Z direction, and directions that perpendicularly intersect the Z direction in a horizontal plane are defined as an X direction and a Y direction, the pair of first permanent magnets include the ridgelines in an X-Z section, a pair of second permanent magnets disposed to face each other in the X direction with the space sandwiched therebetween is further included, the pair of first permanent magnets are arranged below the space, and each of the pair of second permanent magnets can have the same magnetization direction in the X direction. In this manner, it is possible to realize dynamical equilibrium in which the target is balanced and stabilized even in a horizontal plane in the space through addition of a magnetic field formed by the pair of second permanent magnets.

(6) In the embodiment (4) or (5) of the disclosure, the target can have a maximum size of 0.01 mm to 1 mm. In a case in which size reduction of the apparatus is maintained, the size reduction of the apparatus is maintained if the space sandwiched between the ridgelines of the pair of first permanent magnets is relatively narrow and the maximum size, for example, the diameter ranges from 0.01 mm to 1 mm. Furthermore, it is also possible to apply an external force other than a levitation force to particles in an equilibrium state in which the particles are not physically constrained by a non-contact scheme, for example, by sound waves by levitating particles with such a size. It is thus possible to perform various kinds of measurement on the particles and the medium in the surroundings thereof.

(7) Another embodiment of the disclosure relates to a measurement apparatus including: the magnetic levitation apparatus according to (6) described above; an external force application unit configured to apply an external force for oscillating the target levitated by the magnetic levitation apparatus; and a measurement unit configured to detect oscillation of the target and measure attributes of the target correlated with the oscillation of the target.

According to another embodiment (7) of the disclosure, if an external force other than a levitation force is applied to the target in a state in which the target is not physically constrained, the target is deformed. At this time, the shape of the target oscillates due to a restoring force in a three-dimensional dynamical equilibrium state. Additionally, the measurement unit can measure attributes of a target correlated with the oscillation of the target, such as surface tension of a liquid droplet that is a target, surface tension in accordance with a change in concentration of a solution that is a target T, viscosity of a liquid that is a target, and the like.

(8) Another embodiment of the disclosure relates to a measurement apparatus including: the magnetic levitation apparatus according to (6) described above; a support configured to movably support the magnetic levitation apparatus that is levitating the target; and a measurement unit configured to detect a motion of the target following the magnetic levitation apparatus that is moved due to an external force and measure the external force.

According to another embodiment (8) of the disclosure, if an external force such as acceleration or an earthquake is applied to the support, then the magnetic levitation apparatus movably supported by the support moves. The target in the equilibrium state in which the target is levitated by the magnetic levitation apparatus and is not physically constrained follows the movement of the magnetic levitation apparatus and is deformed. The acceleration is obtained from position information, or the magnitude of the earthquake can be measured from the acceleration, by detecting a motion of the target.

(9) Another embodiment of the disclosure relates to a measurement apparatus including: the magnetic levitation apparatus according to (6) described above; an external force application unit configured to apply an external force to move the magnetic levitation apparatus that is levitating the target; and a measurement unit configured to detect oscillation of the target following the magnetic levitation apparatus that is moved due to the external force and measure attributes of the medium, correlated with the oscillation of the target, in the atmosphere in surroundings of the target.

According to another embodiment (9) of the disclosure, if the external force application unit applies an external force, and the magnetic levitation apparatus moves, the target in the equilibrium state in which the target is levitated by the magnetic levitation apparatus and is not physically constrained follows the movement of the magnetic levitation apparatus and moves. At this time, the target oscillates due to a restoring force in a three-dimensional dynamical equilibrium state. Attenuation of the oscillation depends on attributes, for example, viscosity of the medium in the atmosphere in the surroundings of the target. Therefore, it is possible to measure attributes correlated with the oscillation of the target from among attributes of the medium in the atmosphere in the surroundings of the target on the basis of the attenuation of the oscillation.

Hereinafter, the embodiments will be described on the basis of the drawings.

### (1) First Embodiment

### (1-1) Magnetic Levitation Apparatus

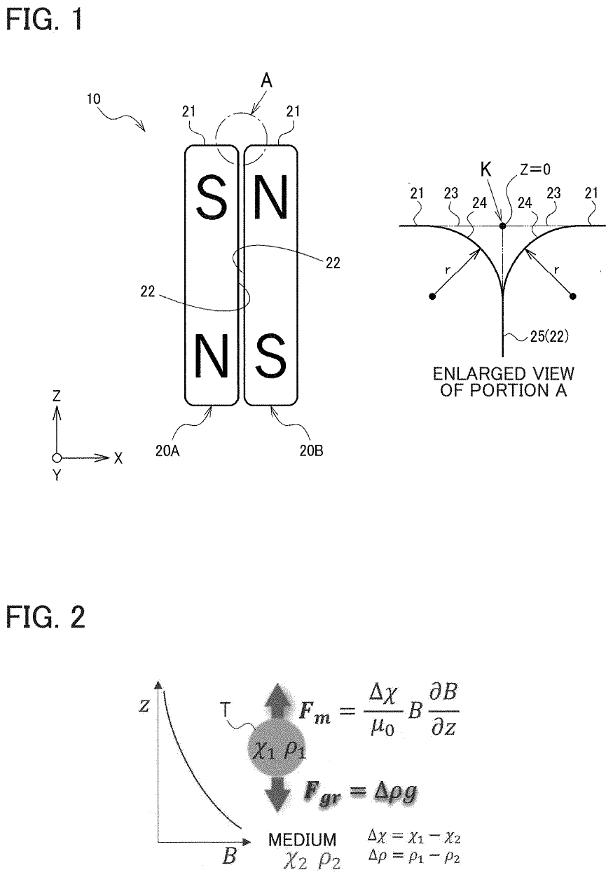

FIG. 1 illustrates a magnetic levitation apparatus according to a first embodiment of the present invention. In FIG. 1, a magnetic levitation apparatus 10 includes a pair of first permanent magnets (also referred to as a pair of permanent magnets) 20A and 20B. Each of the pair of first permanent magnets 20A and 20B is commercially available, has a rectangular parallelepiped shape, for example, and includes a top surface 21 and a side surface 22. As illustrated in the enlarged view of the portion A in FIG. 1, each of the pair of first permanent magnets 20A and 20B includes a ridgeline 24 that chamfers a corner 23 indicated by the dashed line connecting the side surface 22 and the top surface 21 in a vertical section (the X-Z section in FIG. 1). Although the ridgeline 24 can be defined by a fillet radius r as illustrated in the enlarged view of the portion A in FIG. 1, the ridgeline 24 may be defined using a plurality of curvature radii or a straight line.

In FIG. 1, the vertical direction is defined as a Z direction, and directions that perpendicularly intersect the Z direction in a horizontal plane are defined as an X direction and a Y direction. FIG. 1 is a front view of the magnetic levitation apparatus 10 when seen from the front that is parallel to the X-Z plane. As illustrated in FIG. 1, the pair of first permanent magnets 20A and 20B are magnetized in mutually opposite directions in the vertical direction Z. In FIG. 1, the first permanent magnet 20A has an upper portion as an S pole and a lower portion as an N pole while the first permanent magnet 20B has an upper portion as an N pole and a lower portion as an S pole. Therefore, the pair of first permanent magnets 20A and 20B exert attractive forces antiparallel to each other.

The pair of first permanent magnets 20A and 20B are disposed with the side surfaces 22 and 22 facing each other or coming into contact with each other. FIG. 1 illustrates an example in which the side surfaces 22 and 22 face each other while the enlarged view of the portion A in FIG. 1 illustrates a case in which the side surfaces 22 and 22 come into contact with each other, and the contact surfaces will also be referred to as boundary surfaces 25 of the pair of first permanent magnets 20A and 20B. Note that in FIG. 1, Z=0 indicates the same height as the height of the top surface 21 in the vertical direction. The magnetic levitation apparatus 10 magnetically levitate a target T (not illustrated in FIG. 1) that is relatively diamagnetic to a medium in the atmosphere inside a space K located above the ridgeline 24 of each of the pair of first permanent magnets 20A and 20B, particularly, on the upper extension line of the boundary surfaces 25 inside the space K in the vertical section (the X-Z section in FIG. 1) as illustrated in the enlarged view of the portion A in FIG. 1.

### (1-2) Magnetic Force Required for Levitation and Magneto-Archimedes Principle

The gravity acting on the target T is parallel to the Z axis, the direction thereof is vertically downward (with a negative symbol), and the force per unit area can be represented as—ρg (N/m³). Here, p is density (kg/m³) of the object, and g is a gravitational acceleration (m/s²). Also, the Z-axis component of the magnetic force acting on the object is represented by the right side in Equation (1). Here, χ is bulk susceptibility (non-dimensional) of the target T, and μ₀ is a vacuum magnetic permeability (H/m), and B (T) is a “magnitude” of magnetic flux density (with no orientation because this is not a vector). The magnetic flux density B is a function of a location, and (χ/μ₀)(B∇B)z is the same as the right side in Equation (1) when ∇ (nabla) is defined as an operator representing a differential. (∂B/∂Z) in the right side of Equation (1) represents a gradient of the magnetic flux density B in the vertical direction Z. Therefore, a condition for magnetic levitation is as Equation (1) below.

$$[ Expression 1 ]$$

$$ρ g = \frac{χ}{{μ}_{0}} B ( \frac{\partial B}{\partial z} ) \qquad ( 1 )$$

Here, the target T is diamagnetic to the medium in the atmosphere. The diamagnet is a substance with negative bulk susceptibility χ, and the reason that a force of the magnetic field acting on the diamagnet is small is because the magnitude of the bulk susceptibility χ is significantly small (to 10⁻⁶). Since bulk susceptibility χ of an ordinary ferromagnet is typically greater than one, it is possible to ascertain how small the bulk susceptibility χ of the diamagnet is. Also, it is possible to ascertain from Equation (1) that the magnitude of the magnetic force is proportional to a product between the magnitude B of the magnetic flux density and the gradient thereof (∂B/∂Z). Therefore, in regard to a magnetic force generated by a certain magnet, it is possible to determine whether the magnet can realize magnetic levitation by checking a maximum value (absolute value) of B×(∂B/∂Z) in the surroundings of the magnet. Magnitudes of B×(∂B/∂Z) to levitate representative diamagnets are summarized in Table 1.

TABLE 1

| Substance name | Carbon | Bismuth | Water | Alumina |
|---|---|---|---|---|
| B × (∂B/∂Z) necessary for the | 328 | 728 | 1350 | 2701 |
| magnetic levitation (T²/m) | | | | |

Since the magnitude of (∂B/∂Z) typically increases as the maximum value of generated magnetic flux density B (the center magnetic flux density of a coil in a case of a coil such as a superconducting magnet, or the magnetic flux density of the magnetic pole surface in a case of a permanent magnet) increases, the magnetic force generated by the magnet generating the stronger magnetic field is also greater. However, since the equation representing the magnetic force includes the product of the two amounts, namely B and (∂B/∂Z), it is possible to obtain a strong magnetic force as a result even at the portion with the smaller magnetic flux density (smaller B) in principle if it is possible to significantly increase the gradient (∂B/∂Z) of the magnetic flux density. In the present embodiment, a large gradient (∂B/∂Z) of the magnetic flux density is employed.

Although the effect of the medium in the atmosphere where the magnetic levitation apparatus 10 is disposed is ignored in the above discussion, the conditional expression of the magnetic levitation is changed as in Equation (2) by considering the effect of the medium in the Magneto-Archimedes principle.

$$[ Expression 2 ]$$

$$Δρ g = \frac{Δχ}{{μ}_{0}} B ( \frac{\partial B}{\partial z} ) \qquad ( 2 )$$

Here, as illustrated in FIG. 2, Δp represents a value obtained by subtracting the density ρ2 of the surrounding medium from the density ρ1 of the target T to be levitated, and Δχ is a value obtained by subtracting the magnetic susceptibility χ₂ of the surrounding medium from the magnetic susceptibility χ1 of the target T to be levitated.

In comparison with Equation (1) for simple magnetic levitation, p is changed to Δp, and χ is changed to Δχ in Equation (2), which leads to a significant effect. This is because the conditions for magnetic levitation are alleviated by using the Magneto-Archimedes principle. The reason will be described.

Equation (3) obtained by deforming Equation (2) is shown below.

$$[ Expression 3 ]$$

$$B ( \frac{\partial B}{\partial z} ) = \frac{{Δρμ}_{0} g}{Δχ} \qquad ( 3 )$$

Equation (3) represents how the value of B×(∂B/∂Z) needed for magnetic levitation is represented using the magnetic susceptibility and the density. Since a larger magnet is needed as the value of necessary B×(∂B/∂Z) increases, the magnetic levitation is achieved with a simpler structure as the value of necessary B×(∂B/∂Z) decreases. Δp and Δχ in the right side of Equation (3) are parameters that can be controlled in accordance with convenience of a creator, and Δp is preferably smaller while Δχ is preferably larger. On the other hand, since there is no physical property value that can be changed in accordance with convenience of the creator in Equation (2) for simple magnetic levitation, there is no solution other than searching for a magnet with a huge value of B×(∂B/∂Z).

Density of most targets T fall within the range of 10³ to 10⁴ kg/m³ if the targets T to be levitated are solids, and all the targets T have a density of about 10³ kg/m³ if the targets are liquids. In a case in which a solid of an organic substance is levitated as a target T, in particular, it is possible to cause Δp to approach zero as much as possible by using a liquid as a medium and satisfactorily adjusting components of the medium. Although B×(∂B/∂Z) necessary to magnetically levitate a plastic material with density p of about 10³ kg/m³ in the air is about 1500 T²/m, for example, B×(∂B/∂Z) necessary for the magnetic levitation becomes 1/1000, which is 1.5 T²/m if Δp is adjusted to about 1 kg/m³ ( 1/1000 of the density). In other words, it is possible to achieve magnetic levitation with the permanent magnet as well.

Δχ can be increased by using a paramagnetic medium. For example, Δχ is larger when oxygen gas is used as a medium than when the air is used as a medium. Therefore, if oxygen gas is used as a medium, it is possible to achieve magnetic levitation of water even with a commercially available magnet. Also, if a solution containing paramagnetic ions such as Mn or Gd is used as a medium, it is possible to increase Δχ and to reduce Δp at the same time, and the two advantages can be achieved. Therefore, it is suitable to use a paramagnetic solution for the magnetic levitation using the Magneto-Archimedes principle. Additionally, if a paramagnetic medium is used, it is possible to achieve the magnetic levitation even if the target T to be levitated is paramagnetic as long as the target T is relatively diamagnetic as compared with the medium, and it is possible to achieve the magnetic levitation for any substance as the target T.

### (1-3) Magnetic Field Intensity Distribution

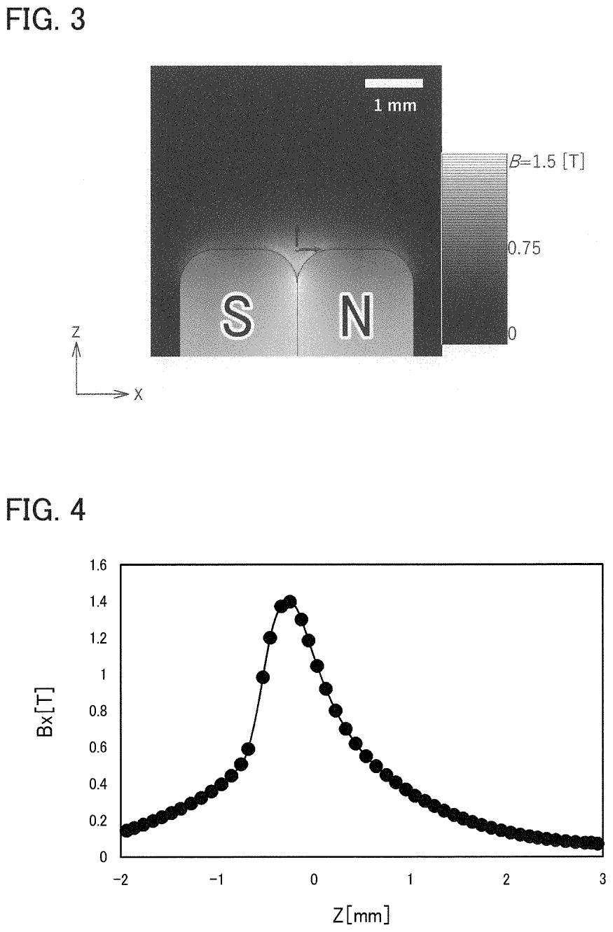

FIG. 3 illustrates magnetic field intensity distribution in the portion A in FIG. 1 in the X-Z plane generated by the magnetic levitation apparatus 10 with the structure in FIG. 1. As the magnetic levitation apparatus 10 with measured magnetic field intensity distribution, the ridgelines 24 of the pair of first permanent magnets 20A and 20B chamfered with the fillet radius of 0.6 mm are used. The pair of first permanent magnets 20A and 20B exerts attractive forces antiparallel to each other. The magnetic line passes from the right magnet 20B to the left magnet 20A around Z=0, and a region with a very strong magnetic field is formed in the space K including the portion between the ridgelines 24 and 24. Magnetic field distribution on the Z axis is as illustrated in FIG. 4, the gradient of the magnetic field is suddenly very steep around Z=0, the magnetic field intensity decreases about 1T with a change of 1 mm, and it is thus possible to ascertain that the gradient (∂B/∂Z) of the magnetic field is in the 1000 T/m order.

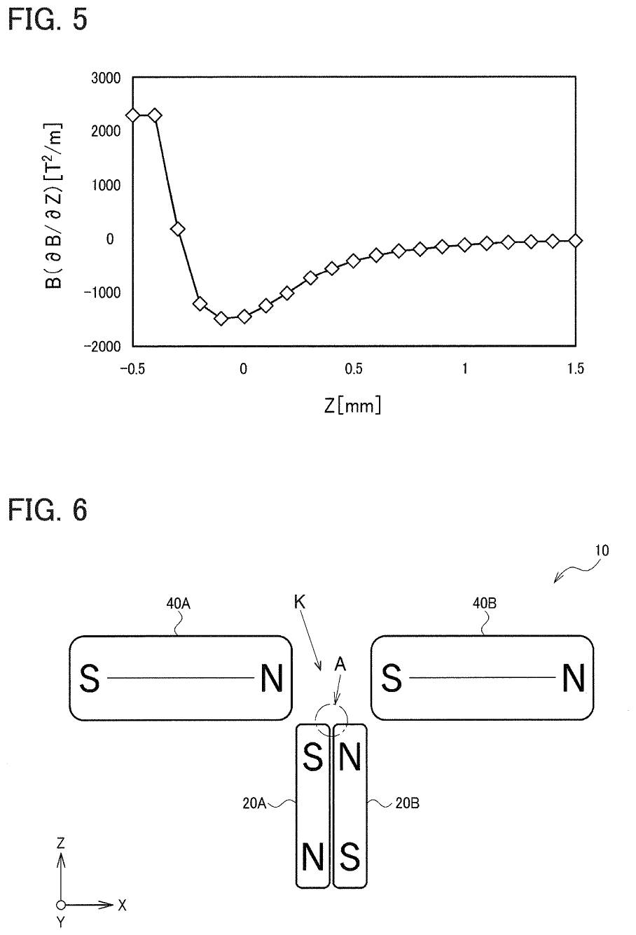

The distribution of B×(∂B/∂Z) as an index of the magnetic force is as illustrated in FIG. 5. In FIG. 5, an absolute value of B×(∂B/∂Z) is about 1500 T²/m around Z=0. It is possible to ascertain from Table 1 that the value indicates the magnitude that enables magnetic levitation of water to be achieved. Note that it is possible to ascertain that magnetic levitation can be achieved even with a permanent magnet if the Magneto-Archimedes principle considering the effect of the medium in the atmosphere is used because the magnetic force of 1500 T²/m becomes 1/1000, which is 1.5 T²/m.

### (2) Second Embodiment

### (2-1) Magnetic Levitation Apparatus

FIG. 6 illustrates a magnetic levitation apparatus according to a second embodiment of the invention. In FIG. 6, a magnetic levitation apparatus 30 includes a pair of second permanent magnets 40A and 40B in addition to the pair of first permanent magnets 20A and 20B. The vertical direction is defined as a Z direction, directions that perpendicularly intersect the Z direction in a horizontal plane are defined as an X direction and a Y direction in FIG. 6 as well, and the pair of first permanent magnets 20A and 20B include ridgelines 24 and 24 in the X-Z section similarly to FIG. 1.

In FIG. 6, a pair of second permanent magnets 40A and 40B disposed to face each other in the X direction with a space K sandwiched therebetween are further included. In this case, the pair of first permanent magnets 20A and 20B are arranged below the space K. Each of the pair of second permanent magnets 40A and 40B has a magnetization direction in the same direction in the X direction. In other words, the second permanent magnet 40A has a left end as an S pole and a right end as an N pole, and the second permanent magnet 40B similarly has a left end as an S pole and a right end as an N pole.

Although the balance in the Z direction is realized in the first embodiment, it is necessary to establish dynamical equilibrium in the X-Y plane as well in order to realize magnetic levitation in a completely non-contact manner. To do so, the pair of second permanent magnets 40A and 40B are added to the pair of first permanent magnets 20A and 20B.

### (2-2) Magnetic Field Intensity Distribution

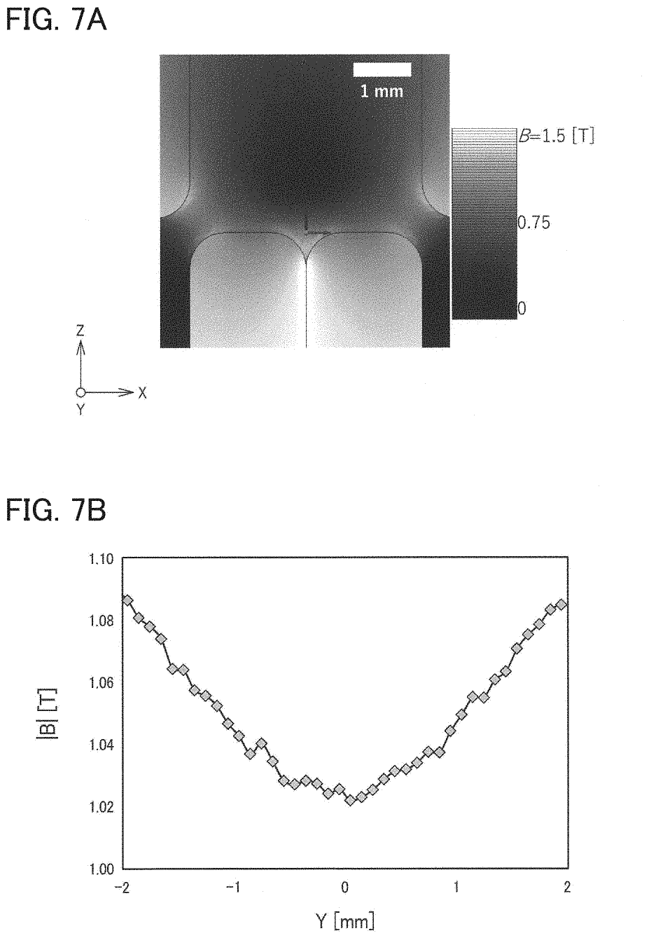

FIG. 7A illustrates magnetic field intensity distribution in the portion A in FIG. 6 in the section of the X-Z plane. Since a region with a very strong magnetic field is formed in the space K including the portion between the ridgelines 24 and 24 in FIG. 7A as well similarly to FIG. 3, the target T is magnetically levitated. Also, a magnetic line created by the pair of second permanent magnets 40A and 40B is directed to the side opposite to a magnetic line created by the pair of first permanent magnets 20A and 20B, the magnetic lines cancel each other, and a portion with a weak magnetic field is formed in a region right above the region with the very strong magnetic field. FIG. 7B illustrates magnetic field intensity distribution in the section of the X-Z plane. Here, the position of Y=0 is a center position of the width of the pair of second magnets 40A and 40B in the Y direction. The portion with the weak magnetic field is formed near the position of Y=0. Since a diamagnet has a characteristic that the diamagnet receives a force from a portion with a strong magnetic field to a portion with a weak magnetic field (receives a repulsive force from a magnet), the target T gets settled at the portion with the weak magnetic field, and dynamical equilibrium is also achieved in the X-Y plane as well. In this manner, complete magnetic levitation is realized.

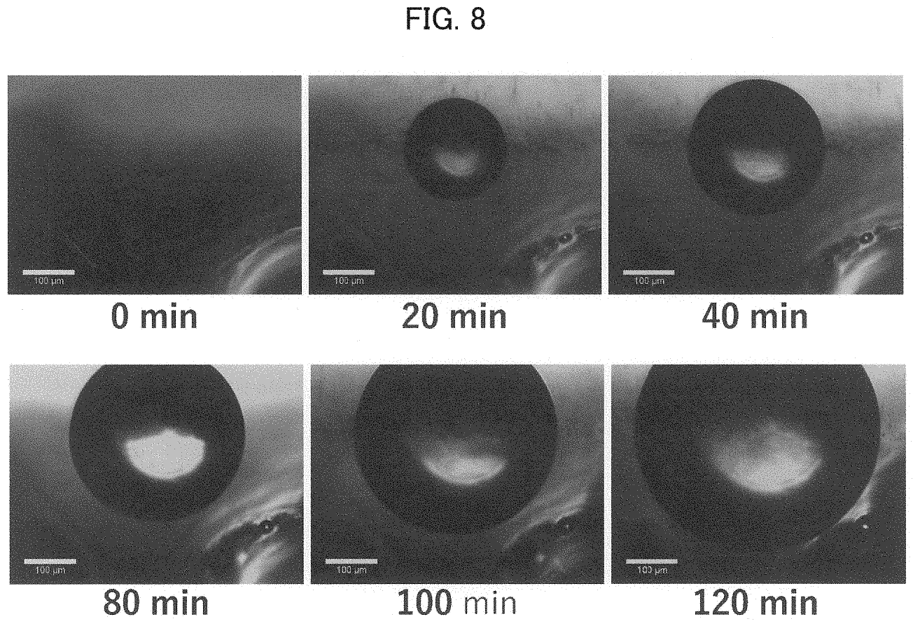

A result of carrying out a magnetic levitation experiment of water using the magnetic levitation apparatus 30 illustrated in FIG. 6 is shown in FIG. 8. In the experiment, mist is generated by applying ultrasonic waves to water, and a state where the mist gathers and increases in size is imaged as in FIG. 8. As can be understood from FIG. 8, it is possible to easily cause a water droplet with a diameter of about 0.5 mm to float.

### (2-3) Influences of Radius Defining Ridgelines

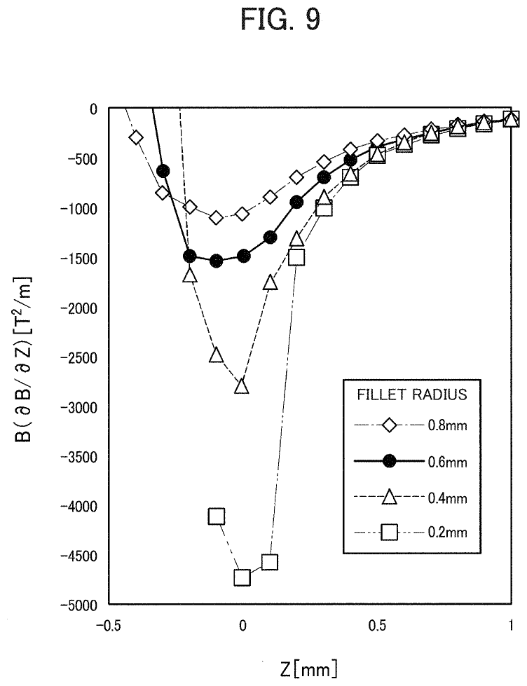

Distribution of B×(∂B/∂Z) depends on the fillet radius r illustrated in FIG. 1 that defines the ridgelines 24 of the pair of first permanent magnets 20A and 20B. As illustrated in FIG. 9, if the fillet radius is equal to or less than 0.6 mm, an absolute value of B×(∂B/∂Z) is greater than 1500 T²/mm, and magnetic levitation of water can be achieved. However, if the fillet radius is 0.8 mm, the absolute value of B×(∂B/∂Z) is 1100 T²/m, and it is thus not possible to achieve magnetic levitation of water. Therefore, since the region where the target T floats is narrower as the fillet radius decreases although a stronger magnetic force is obtained as the fillet radius decreases, it is only necessary to select a magnet in accordance with a purpose.

### (3) Third Embodiment

### (3-1) Magnetic Levitation Apparatus

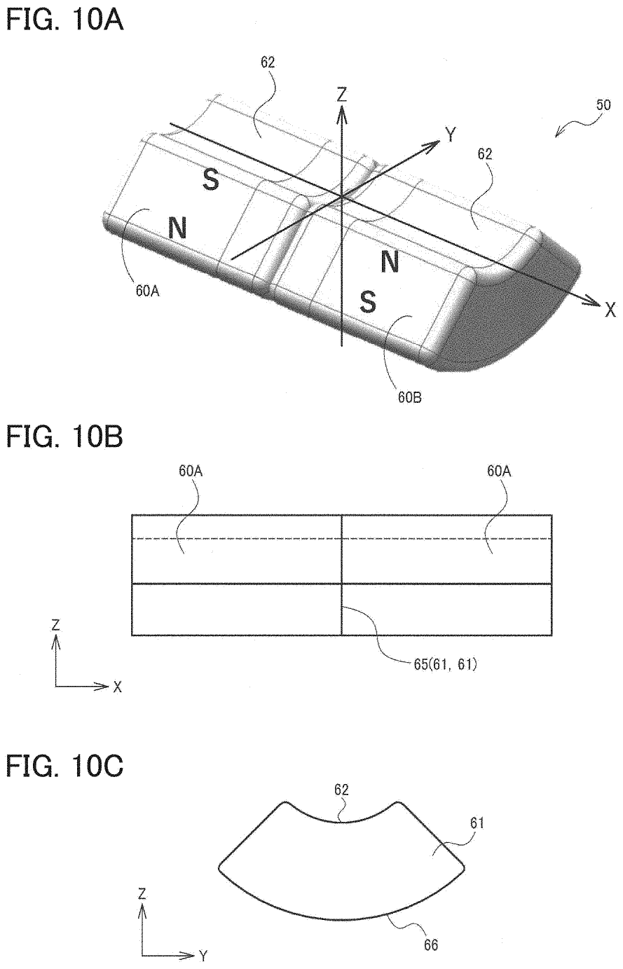

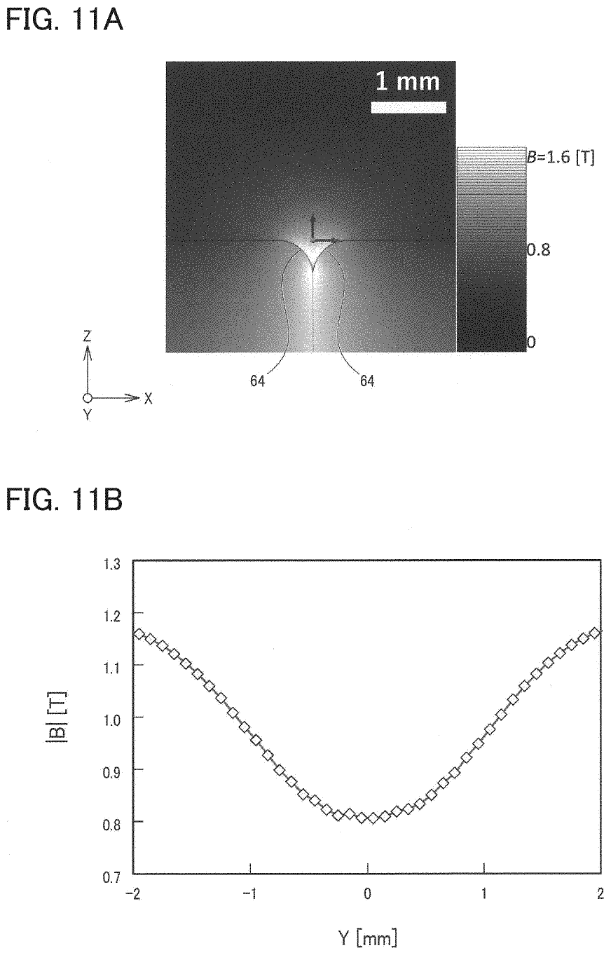

FIGS. 10A to 10C illustrate a magnetic levitation apparatus according to a third embodiment of the invention. In FIGS. 10A to 10C, a magnetic levitation apparatus 50 includes a pair of first permanent magnets 60A and 60B. Thus, the magnetic levitation apparatus 50 does not include the pair of second permanent magnets 40A and 40B that are needed in the second embodiment. The pair of first permanent magnets 60A and 60B have structures common to those of the pair of first permanent magnets 20A and 20B in the first embodiment. As structures common to those of the side surface 22, the top surface 21, the ridgeline 24, and the boundary surface 25 in the first embodiment, each of the pair of first permanent magnets 60A and 60B includes a side surface 61, a top surface 62, a ridgeline 64, and a boundary surface 65 (see FIG. 11A as well).

Each of the pair of first permanent magnets 60A and 60B has the top surface 62 formed into an arc shape projecting downward in the Y-Z section as illustrated in FIG. 10C. A bottom surface 66 may also be formed into an arc shape that is a figure similar to that of the top surface 62. A commercially available permanent magnets can be used as the pair of first permanent magnets 60A and 60B with such a shape as well. As for the size of the magnets 60A and 60B in one example, the outer diameter is 8.7 mm, the inner diameter is 3.0 mm, the thickness is 9.0 mm, and the center angle of the arc is 90°. Here, the fillet radius of the three-dimensional ridgeline portion is set to 0.6 mm.

### (3-2) Magnetic Field Intensity Distribution

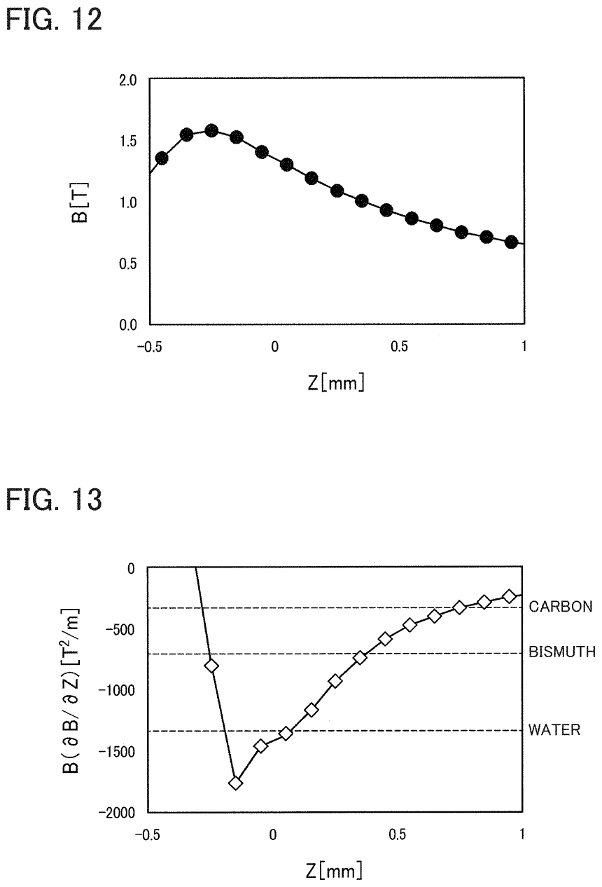

FIG. 11A illustrates magnetic field intensity distribution in the section of the X-Z plane of the magnetic levitation apparatus 50, and FIG. 12 illustrates magnetic field intensity distribution in the Z direction in FIG. 11A. It is possible to ascertain that a magnetic field created by the pair of first permanent magnets 60A and 60B has significantly high magnetic field intensity in a space located above the ridgelines 64 and 64 in the X-Z section and is suddenly attenuated in the surroundings thereof similarly to the first and second embodiments. FIG. 11B illustrates magnetic field intensity distribution in the section of the X-Z plane. Here, the position of Y=0 is a center position of the width of the pair of first magnets 60A and 60B in the Y direction. A portion with a weak magnetic field is formed near the position of Y=0 in FIG. 11B as well similarly to FIG. 7B. Since the target T gets settled at a place where the magnetic field is weak, dynamical equilibrium is achieved even within the X-Y plane. In this manner, complete magnetic levitation is realized.

Magnetic field intensity distribution in the Z-axis direction in the magnetic field intensity distribution in the X-Z plane illustrated in FIG. 11A is illustrated in FIG. 12, and the value of B×(∂B/∂Z) calculated from FIG. 12 is illustrated in FIG. 13. In FIG. 13, Z=0 indicates the upper end of the boundary surface 25, the value (absolute value) of B×(∂B/∂Z) needed for magnetic levitation of water illustrated in Table 1 is sufficiently exceeded near Z=0, and it is possible to ascertain that magnetic levitation of water as the target T is realized. Additionally, it is also possible to ascertain from FIG. 13 that magnetic levitation of bismuth or carbon as the target T is realized.

### (4) Fourth Embodiment

### (4-1) Measurement Apparatus

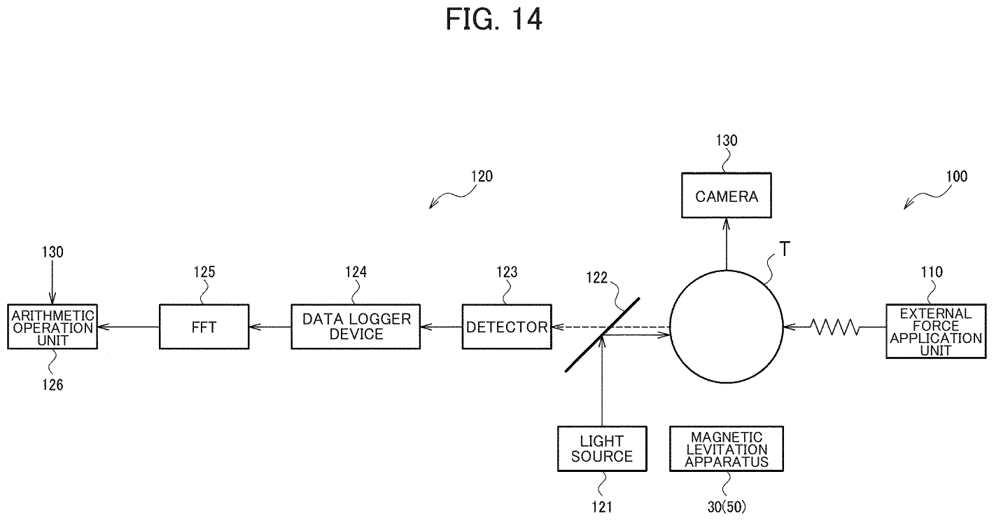

FIG. 14 illustrates a measurement apparatus using the magnetic levitation apparatus 30 (50) illustrated in the second embodiment or the third embodiment as a fourth embodiment of the invention. A measurement apparatus 100 includes the magnetic levitation apparatus 30 (50) configured to levitate the target T, an external force application unit 110 configured to apply an external force for oscillating the target T levitated by the magnetic levitation apparatus 30 (50), and a measurement unit 120 configured to detect oscillation of the target T and measure attributes of the target T correlated with the oscillation of the target T. Hereinafter, surface tension of a liquid droplet that is a target T, surface tension with a change in concentration of a solution that is a target T, and viscosity of a liquid that is a target T will be described as attributes of the measured targets T.

The measurement unit 120 can include, for example, a light source 121, a half mirror 122, a detector 123, a data logger device 124, a fast Fourier transform (FFT) analysis unit 125, and an arithmetic operation unit 126. Also, in a case in which the shape of the target T, for example, a radius of the liquid droplet is not known, in particular, it is also possible to provide a camera 130 that is preferably provided with a lens or a microscope for imaging the target T.

### (4-2) Measurement of Surface Tension

If the external force application unit 110 applies sound waves, for example, to the target T when the liquid droplet that is the target T is caused to float in the air by the magnetic levitation apparatus 30 (50), then the target T oscillates while being deformed between a true sphere to an ellipsoidal sphere. At this time, the target T oscillates using surface tension as a restoring force with the center of gravity of the target T kept in a three-dimensional dynamical equilibrium state. The frequency f of oscillation at that time is represented as Equation (4) below.

$$[ Expression 4 ]$$

$$f = \sqrt{\frac{L ( L - 1 ) ( L + 2 ) σ}{4 {π}^{2} ρ {R}^{3}}} \qquad ( 4 )$$

In Equation (4), σ represents surface tension of the liquid droplet that is the target T, R represents the radius of the liquid droplet, ρ represents the density of the liquid droplet, and L represents a mode (natural number). If L=2, R=0.2 mm, σ=72.8 mN/m, and ρ=998 kg/m³ (20° C.) are substituted to Equation (4) when a spherical water droplet with a radius of 0.2 mm is floating, the frequency f of oscillation is f=1.36 kHz. Conversely, it is possible to calculate the surface tension a of the liquid droplet that is the target T by examining the frequency f of oscillation of the liquid droplet.

The radius R of the liquid droplet can be obtained from the diameter of the liquid droplet imaged by the camera 130. The liquid droplet is irradiated with LED light or the like from the light source 121 through the half mirror 122, and reflected light is detected by the detector 123 such as a photodiode. A peak frequency f is obtained by taking data including an oscillation component into the data logger device 124 for performing digital processing and storage, and performing fast Fourier transform on the taken data using the FFT analysis unit 125. The arithmetic operation unit 126 can perform an arithmetic operation for the surface tension a by substituting the obtained frequency f, the mode L, and the density p and the radius R of the liquid droplet to Equation (4) above.

(4-3) Measurement of Surface Tension with Change in Concentration of Solution

In the present embodiment, the target T may be not only a pure liquid but also an aqueous solution or the like containing a surfactant, for example. The magnetic levitation apparatus 30 (50) can cause a very small water droplet to flow. The concentration of the solution increases as a component of a solvent in the levitated aqueous solution evaporates. In the present embodiment, this can be used to perform measurement of the surface tension with a change in concentration of the surfactant from one water droplet. As for the amount of sample for the measurement in the present embodiment, it is possible to perform the measurement with the amount that is as small as the amount less than 1 μm.

For example, it is assumed that the radius R of the aforementioned water droplet has become ⅕ due to the evaporation of water that of a solvent (due to this, the concentration of the surfactant becomes 125 times) and the magnitude of the surface tension has become a half (a change to this extent is typically achieved). At this time, the frequency of the mode L=2 is supposed to be 10.7 kHz. The maximum size of the diameter or the like of the liquid droplet is assumed to be about 0.01 mm to 1 mm, and it is possible to easily detect the size of the liquid droplet using the camera 130 with a zooming function or the camera provided in a microscope.

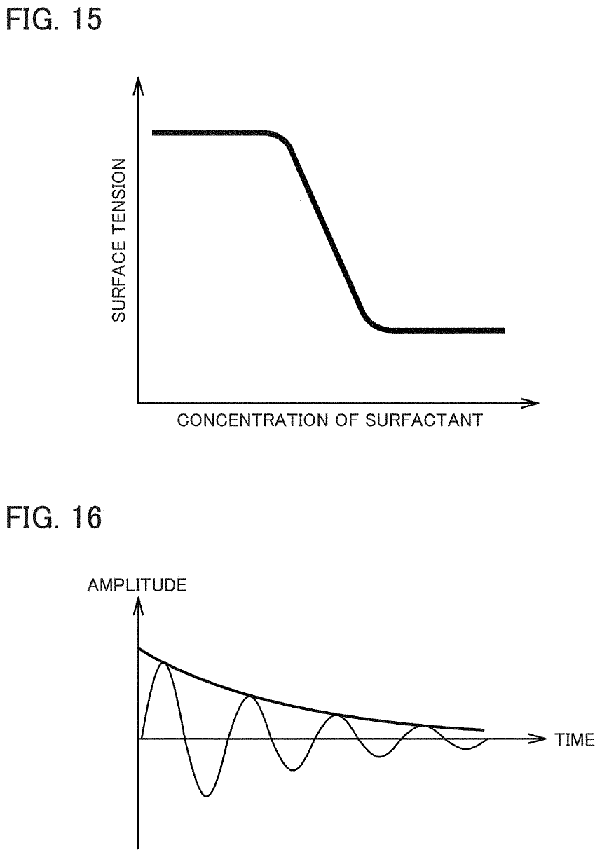

In general, the surface tension of a surfactant tends to decrease as the concentration increases. This is not simple as in FIG. 15 because the change is not monotonous. When the concentration of the surfactant is gradually raised, a change in concentration until the surface tension gets settled at a certain constant value after the surface tension starts to decrease is expressed approximately by a two-digit number. Therefore, if the surface tension is measured when the radius of the liquid changes by a one-digit number, that is, when the concentration changes by a three-digit number, it is possible to sufficiently track the change in surface tension depending on the concentration.

Therefore, in order to measure concentration dependency of the surface tension, it is necessary to prepare solutions with all concentrations and to measure the surface tension of each solution, which is significantly burdensome. Also, the concentration dependency of the surface tension changes even if a very small amount of impurities are contained, it is thus desirable to perform the measurement using a sample with high purity obtained through a purification process such as recrystallization in order to obtain accurate data, the amount of samples decreases at that time as a matter of course, and it is thus necessary to prepare a large amount of specimens for the experiment. In this regard, the present embodiment has an advantage that it is possible to perform the measurement of the surface tension with a change in concentration of the surfactant using just one water droplet.

### (4-4) Measurement of Viscosity of Liquid

If the external force application unit 110 applies an external force, preferably an external force in a physically non-contact scheme, for example, sound waves to the target T when the liquid droplet that is the target T is caused to float in the air by the magnetic levitation apparatus 30 (50), then the target T oscillates as in FIG. 16. Attenuation of the oscillation in FIG. 16 is caused by the viscosity of the liquid that is the target T, and when the amplitude at the clock time t=0 is defined as A, and the attenuation time is defined as τ, the attenuated amplitude y is represented by Equation (5) below. In Equation (5), ω satisfies ω=2πf.

$$[ Expression 5 ]$$

$$y = {Ae}^{- \frac{t}{τ}} sin ( ω t ) \qquad ( 5 )$$

A relationship between the clock time t and the amplitude y in Equation (5) can be obtained by the measurement apparatus 100 illustrated in FIG. 14. Here, light reflected by the oscillating target T is received by the detector 123 in association with the clock time t. The FFT analysis unit 125 can thus obtain the amplitude y at each clock time t.

On the other hand, if the restoring force in Equation (5) is represented by a spring constant k, it is assumed that the mass, the viscosity, and the radius of the liquid droplet that is the target T are m, η, and r, respectively, the following differential equation (6) is established.

[Expression 6]

m(∂²y/∂t²)=−ky−6πηr(∂y/∂t) (6)

From Equation (6), Equation (7) below is established.

[Expression 7]

τ=m/(6πηr) (7)

The arithmetic operation unit 126 in FIG. 14 can obtain the viscosity η by substituting the known mass m, the radius r obtained through measurement using the camera 130, and τ obtained through the arithmetic operation as described above to Equation (7). Note that it is possible to ascertain from Equation (7) that the attenuation time τ is shorter as the viscosity η increases.

### (5) Fifth Embodiment

### (5-1) Measurement Apparatus

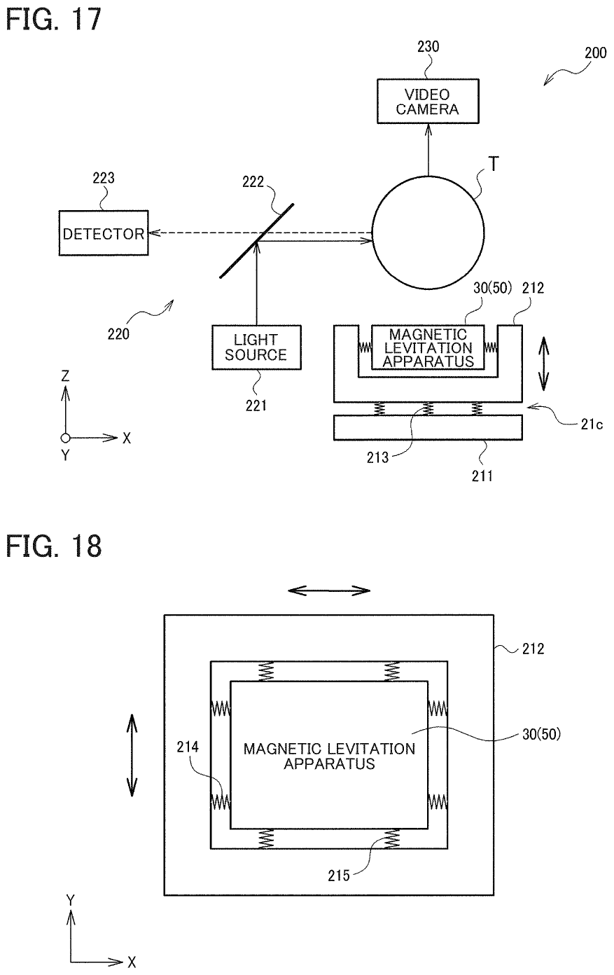

FIG. 17 illustrates, as a fifth embodiment of the invention, a measurement apparatus using the magnetic levitation apparatus 30 (50) illustrated in the second embodiment or the third embodiment. A measurement apparatus 200 includes the magnetic levitation apparatus 30 (50), a support 210 configured movably support the magnetic levitation apparatus 30 (50) that is levitating the target T, and a measurement unit 220 configured to detect a motion of the target T following the magnetic levitation apparatus 30 (50) that is moved due to an external force and measure the external force.

The support 210 includes a base 211 and a lift 212. The base 211 supports the lift 212 via an elastic body, for example, a spring 213 stretched in the vertical direction Z. The lift 212 is formed at a frame in a plan view as illustrated in FIG. 18 and supports the magnetic levitation apparatus 30 (50) via elastic bodies, for example, springs 214 and 215 inside the frame. The spring 214 is stretched in the X direction, and the spring 215 is stretched in the Y direction. Therefore, if an external force acts on the base 211, the magnetic levitation apparatus 30 (50) is displaced in three-dimensional X, Y, and Z coordinates. The target T levitated by the magnetic levitation apparatus 30 (50) follows the displacement of the magnetic levitation apparatus 30 (50) and is displaced.

The measurement unit 220 illustrated in FIG. 17 can include a light source 221, a half mirror 222, a detector 223, and the like similarly to FIG. 14, and illustration of later parts than the detector 223 is omitted. As the later parts than the detector 223, it is possible to provide a data logger device that records a movement track of the target T and an arithmetic operation unit that performs an arithmetic operation for the acceleration and the magnitude of an earthquake from the movement track of the target T, for example. Although an X-axis measurement unit is illustrated in the measurement unit 220 illustrated in FIG. 17, it is possible to include an orthogonal three-axis detector by similarly providing a Y-axis measurement unit and a Z-axis measurement unit. The measurement unit 220 specifies the X, Y, Z coordinate position of the center of gravity of the target T displaced every predetermined time. In other words, the position of the target T when an external force such as an acceleration or an earthquake acts on the base 221 is tracked. The measurement unit 220 can perform an arithmetic operation for the acceleration from the movement track of the target displaced every predetermined time, for example. Alternatively, the measurement unit 220 can create an earthquake waveform or calculate seismic intensity by a known method from accelerations in the three axes X, Y, and Z directions. The measurement unit 220 can be provided with a video camera 230, for example, for recording the X, Y, and Z coordinate position of the center of gravity of the target T displaced every predetermined time, instead of the three-axis acceleration detector.

### (5-2) Measurement of Acceleration or Seismic Intensity

Since the magnetic levitation apparatus 30 (50) levitates the target T and also realize dynamical equilibrium even in a horizontal plane, the relative position of the levitated target T with respect to the magnetic levitation apparatus 30 (50) is uniquely defined. This does not change even if the magnetic levitation apparatus 30 (50) moves. Therefore, when the base 211 illustrated in FIG. 17 is displaced due to an external force such as an earthquake, the target T levitated by the magnetic levitation apparatus 30 (50) also follows the displacement of the magnetic levitation apparatus 30 (50) and is displaced. It is thus possible to measure the magnitude of the acceleration of the external force acting on the base 211 and the magnitude of the earthquake from the three-axis acceleration if the movement of the target T is tracked and the movement track is recorded.

Note that measurement apparatuses with different responses may be used for sensing of a slow motion and for sensing of a fast motion. One of solutions is to change magnetic field distribution, and it is only necessary to change the size and the disposition of the magnets. As another solution, it is also possible to change a response of the measurement apparatus by changing the mass and the size of the target T to be levitated.

### (6) Sixth Embodiment

### (6-1) Measurement Apparatus

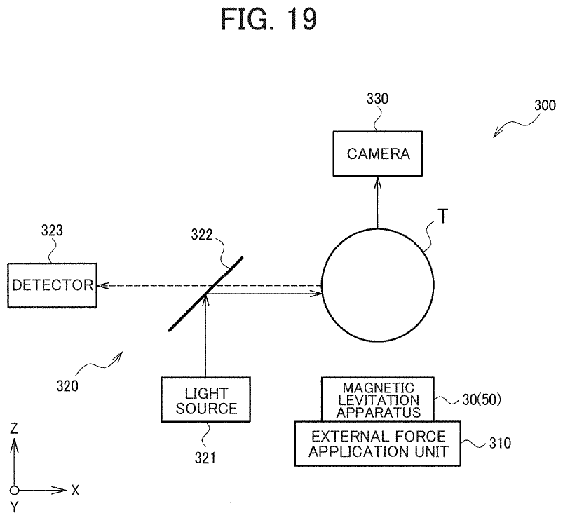

FIG. 19 illustrates, as a sixth embodiment of the invention, a measurement apparatus using the magnetic levitation apparatus 30 (50) according to the second embodiment or the third embodiment. A measurement apparatus 300 includes the magnetic levitation apparatus 30 (50) configured to levitate the target T, an external force application unit 310 configured to apply an external force to the magnetic levitation apparatus 30 (50) and move the magnetic levitation apparatus 30 (50), and a measurement unit 320 configured to detect oscillation of the target T with the movement of the magnetic levitation apparatus 30 (50) and measure attributes of a medium, correlated with the oscillation of the target T, in an atmosphere in the surroundings of the target T. The external force application unit 310 may oscillate the magnetic levitation apparatus 30 (50) using a contact external force such as hitting.

The measurement unit 320 illustrated in FIG. 19 can include a light source 321, a half mirror 322, a detector 323, and the like similarly to FIG. 14, and illustration of later parts than the detector 323 is omitted. As the later parts than the detector 323, it is possible to provide a data logger device, an FFT analysis unit, and an arithmetic operation unit similarly to FIG. 14. Also, in a case in which the shape of the target T, for example, a radius of a liquid droplet is not known, in particular, it is also possible to provide a camera 330 that preferably includes a lens or a microscope to image the target T.

### (6-2) Measurement of Viscosity of Atmospheric Medium

In the present embodiment, any of a scheme in which the target T is displaced due to an external force as in the fourth embodiment and a scheme in which the magnetic levitation apparatus 30 (50) is displaced due to an external force from the external force application unit 310 similarly to the fifth embodiment may be employed. In a case in which the magnetic levitation apparatus 30 (50) moves in a state in which the target T is levitated, for example, the levitated target T follows the movement and moves. At this time, the target T oscillates due to a restoring force in a three-dimensional dynamical equilibrium state.

Attenuation of the oscillation of the target T depends on attributes, for example, viscosity of the medium in the atmosphere in the surroundings of the target T. Therefore, it is possible to measure attributes correlated with the oscillation of the target from among attributes of the medium in the atmosphere in the surroundings of the target on the basis of the attenuation of the oscillation. Equations (5), (6), and (7) can be applied to oscillation of the medium as well. Here, in a case of oscillation that leads to deformation of the target T but does not lead to a change in position of the center of gravity, the viscosity inside the target T affects the oscillation, and it is thus possible to know the viscosity of the target T. On the other hand, in a case of oscillation that does not cause a change in shape of the target T but leads to a change in the position of the center of gravity of the target T, the medium in the surroundings of the target T affects the oscillation, and it is thus possible to know the viscosity of the medium in the surroundings.

If the measurement apparatus is used, then it is possible to measure the viscosity of gas merely by filling the entire measurement apparatus with a very small amount of gas. Note that the medium in the surroundings may be a liquid.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A magnetic levitation apparatus comprising:
a pair of permanent magnets,
wherein each of the pair of permanent magnets includes a side surface, a top surface, and a ridgeline that chamfers a corner connecting the side surface to the top surface in a vertical section,
wherein a vertical direction is defined as a Z direction, and directions that perpendicularly intersect the Z direction in a horizontal plane are defined as an X direction and a Y direction, the pair of permanent magnets include the ridgelines in an X-Z section,
the top surface of each of the pair of permanent magnets is formed into an arc shape projecting downward in a Y-Z section, and
the pair of permanent magnets are magnetized in mutually opposite directions in the Z direction and are aligned with the side surfaces facing each other or coming into contact with each other, such that a target that is diamagnetic to a medium in an atmosphere is magnetically levitated in a space located above the ridgeline of each of the pair of permanent magnets in the vertical section.

2. The magnetic levitation apparatus according to claim 1, wherein the ridgeline of each of the pair of permanent magnets chamfers the corner connecting the side surface to the top surface in accordance with a predetermined radius.

3. The magnetic levitation apparatus according to claim 2, wherein B×(∂B/∂z) that is a product between a magnetic flux density B (T) and ∂B/∂Z (T/m) that is a gradient of the magnetic flux density B in the vertical direction changes depending on the radius, and the radius is set in accordance with a type of the target.

4. The magnetic levitation apparatus according to claim 1, wherein the target has a maximum size of 0.01 mm to 1 mm.

5. A measurement apparatus comprising:
the magnetic levitation apparatus according to claim 1;
an external force application unit configured to apply an external force for oscillating the target levitated by the magnetic levitation apparatus; and
a measurement unit configured to detect oscillation of the target and measure attributes of the target correlated with the oscillation of the target.

6. A measurement apparatus comprising:
the magnetic levitation apparatus according to claim 1;
a support configured to movably support the magnetic levitation apparatus that is levitating the target; and
a measurement unit configured to detect a motion of the target following the magnetic levitation apparatus that is moved due to an external force and measure the external force.

7. A measurement apparatus comprising:
the magnetic levitation apparatus according to claim 1;
an external force application unit configured to apply an external force to move the magnetic levitation apparatus that is levitating the target; and
a measurement unit configured to detect oscillation of the target following the magnetic levitation apparatus that is moved due to the external force and measure attributes of the medium, correlated with the oscillation of the target, in the atmosphere in surroundings of the target.

8. A magnetic levitation apparatus comprising:
a pair of first permanent magnets; and
a pair of second permanent magnets,
wherein each of the pair of first permanent magnets includes a side surface, a top surface, and a ridgeline that chamfers a corner connecting the side surface to the top surface in a vertical section,
wherein a vertical direction is defined as a Z direction, and directions that perpendicularly intersect the Z direction in a horizontal plane are defined as an X direction and a Y direction, the pair of first permanent magnets include the ridgelines in an X-Z section,
the pair of second permanent magnets are disposed to face each other in the X direction with a space sandwiched therebetween,
the pair of first permanent magnets are arranged below the space,
each of the pair of second permanent magnets has a same magnetization direction that is the X direction, and
the pair of first permanent magnets are magnetized in mutually opposite directions in the Z direction and are aligned with the side surfaces facing each other or coming into contact with each other, such that a target that is diamagnetic to a medium in an atmosphere is magnetically levitated in the space located above the ridgeline of each of the pair of first permanent magnets in the vertical section.

9. The magnetic levitation apparatus according to claim 8, wherein the ridgeline of each of the pair of first permanent magnets chamfers the corner connecting the side surface to the top surface in accordance with a predetermined radius.

10. The magnetic levitation apparatus according to claim 9, wherein B×(∂B/∂Z) that is a product between a magnetic flux density B (T) and ∂B/∂Z (T/m) that is a gradient of the magnetic flux density B in the vertical direction changes depending on the radius, and the radius is set in accordance with a type of the target.

11. The magnetic levitation apparatus according to claim 8, wherein the target has a maximum size of 0.01 mm to 1 mm.

12. A measurement apparatus comprising:
the magnetic levitation apparatus according to claim 8;
an external force application unit configured to apply an external force for oscillating the target levitated by the magnetic levitation apparatus; and
a measurement unit configured to detect oscillation of the target and measure attributes of the target correlated with the oscillation of the target.

13. A measurement apparatus comprising:
the magnetic levitation apparatus according to claim 8;
a support configured to movably support the magnetic levitation apparatus that is levitating the target; and
a measurement unit configured to detect a motion of the target following the magnetic levitation apparatus that is moved due to an external force and measure the external force.

14. A measurement apparatus comprising:
the magnetic levitation apparatus according to claim 8;
an external force application unit configured to apply an external force to move the magnetic levitation apparatus that is levitating the target; and
a measurement unit configured to detect oscillation of the target following the magnetic levitation apparatus that is moved due to the external force and measure attributes of the medium, correlated with the oscillation of the target, in the atmosphere in surroundings of the target.
